(19) United States
(12) Patent Application Publication
(10) Pub. No.: US 2004/0091231 A1
(43) Pub. Date: May 13, 2004

(54) Optical subassembly tester and testing method

(76) Inventors: Rudolf J. Hofmeister, Sunnyvale, CA (US); Dev E. Kumar, San Jose, CA (US); Samantha R. Bench, Whitefish, MT (US)

Correspondence Address: R. BURNS ISRAELSEN, WORKMAN NYDEGGER, 1000 Eagle Gate Tower, 60 East South Temple, Salt Lake City, UT, 84111, US

(21) Appl. No.: 10/695,203

(22) Filed: Oct. 28, 2003

Related U.S. Application Data
(60) Provisional application No. 60/425,002, filed on Nov. 8, 2002.

(51) Int. Cl. G02B 6/00

(52) U.S. Cl. 385/147

(57) ABSTRACT

An apparatus and method are provided for testing an optical subassembly of an optoelectronic device before attaching the electrical component. The method includes assembling a test circuit on a printed circuit board (“PCB”) and placing the PCB in the base portion of a clamping device. The optical subassembly is assembled and electrically connected to a flexible circuit. The clamping device is closed to form a temporary electrical connection between the flexible circuit and the test circuit. The flexible circuit is, in turn, connected to the optical subassembly. A data stream is transmitted through the optical subassembly and evaluated for compliance.

### CROSS-REFERENCE TO RELATED APPLICATIONS

This application claims priority to U.S. Provisional Application Serial No. 60/425,002, filed Nov. 8, 2002 and entitled “OPTICAL SUBASSEMBLY TESTER AND TESTING METHOD,” which application is incorporated herein by reference in its entirety.

### BACKGROUND OF THE INVENTION

1. Field of the Invention

The present invention relates generally to the field of fiber optic devices. More particularly, the present invention relates to an assembly and method for testing the optical component of an optoelectronic device before attaching the electrical components.

2. Relevant Technology

Optoelectronic devices, such as transceivers and transponders, are devices that are capable of performing two functions. First, a transmitting portion of an optoelectronic device receives electrical signals, translates the electrical signals to optical signals, and then transmits the optical signals. Second, a receiving portion of an optoelectronic device receives optical signals, translates the optical signals to electrical signals, and then transmits the electrical signals. Note that an optoelectronic device may have both transmitting and receiving capabilities, such as those found in a transceiver or transponder.

In the manufacture of optoelectronic devices, each device is tested to ensure that it functions properly before selling the device to a customer. Since optoelectronic devices operate in a variety of environments (with respect to temperature, supply voltage, etc.), the devices are preferably tested under conditions similar to those found in such operating environments.

Testing optoelectronic devices has, however, proven to be a costly activity. This cost is related to the fact that optoelectronic devices are not readily disassembled or repaired once its components have been assembled. Optoelectronic devices are composed of an electrical component and a pair of optical components. The electrical component transmits and receives electrical signals, whereas the optical components transmit and receive optical signals. An optoelectronic device will malfunction if the electrical component, either of the optical components, or their connection malfunctions.

Typically, an optoelectronic device is tested after it has been completely assembled. When an optoelectronic device is found to be malfunctioning, disassembling the optoelectronic device is time consuming, and thus expensive, and may render unusable the device's electrical component, optical components or both. Further, for some types of malfunctions, testing the optoelectronic device as a whole makes it difficult to determine which component of the device is malfunctioning.

Additionally, when optical components of optoelectronic devices are tested before assembling with corresponding electrical components, the optoelectronic device's components have conventionally been permanently bonded to the testing equipment. This has been required to provide a strong connection in order to test high-speed (e.g., 10 Gb) protocols. However, permanently bonding the optical component to the testing equipment requires additional process steps and may damage the electrical connect system (e.g., leads or flexible circuit). Because of this, it is usually favored to test the optoelectronic device after the optical and electronic components have been assembled together.

Thus, it would be beneficial to test the electrical component and the optical components of an optoelectronic device separately before these components are joined to form an optoelectronic device. In this way, manufacturing costs are reduced, malfunctions are more easily and accurately diagnosed, and fewer components are damaged in disassembly.

### SUMMARY OF THE INVENTION

An optical component or optical subassembly (“OSA”), of an optoelectronic device is tested separately from the device's electrical components. Manufacturing and testing costs are lowered by detecting malfunctioning optical components prior to their assembly with the device's electrical components.

The optical component of an optoelectronic device is connected to a flex circuit or other lead system and placed in a testing assembly that creates a temporary connection between a test circuit and the optical component. The temporary connection is created by mechanically pressing bonding pads or electrical connection of the flex circuit or other lead system to an electrical interface on the test circuit. Magnets, pressure fixtures, screws or other clamping mechanisms are used to help make a secure, temporary connection. The test board and clamping mechanism provide a high quality electrical connection between the OSA and the test board without using solder or other permanent connection means.

When the optical component to be tested is a receiver optical subassembly (ROSA), an optical signal is sent to the optical input port of the ROSA. If the ROSA is at least partially functional and all necessary connections in the signal path are functional, the ROSA converts the optical signal into an electrical signal, which is then conveyed to a tester or other evaluation device. The electrical signal is evaluated to detect any errors that may indicate a malfunctioning optical component.

When the optical component to be tested is a transmitter optical subassembly (TOSA), an electrical signal is sent to the electrical input port of the TOSA. If the TOSA is at least partially functional and all necessary connections in the signal path are functional, the TOSA converts the electrical signal into an optical signal, which is then conveyed to a tester or other evaluation device. The optical signal is evaluated to detect any errors that may indicate a malfunctioning optical component.

The test board and clamping mechanism enables full data rate testing of the OSA, typically at data rates ranging from 1 Gb/s to 10 Gb/s, as opposed to the simple dead/alive, voltage/current tests performed in the past on OSA's prior to assembly with the device electronics. By testing the OSA's separately from the device electronics, the majority of device failures are detected prior to assembly of the OSA's with the device electronics, thereby greatly reducing the manufacturing costs associated with such failures.

In one embodiment of the present invention, a host computer performs the test on a transmitter optical assembly (“TOSA”). A host computer is attached to the test circuit while the TOSA is in the tester assembly. The host computer sends an electrical signal to the test circuit, which then sends a test signal to the TOSA. The TOSA then transmits the test pattern to a digital communications analyzer (“DCA”). The host computer then evaluates a return signal from the DCA to determine whether the optical component is functioning properly. In another embodiment, a bit error rate tester (“BERT”) transmits and receives the signals.

In another embodiment of the present invention, a host computer performs the test on a receiver optical assembly (“ROSA”). A host computer is attached to the test circuit while the ROSA is in the tester assembly. The host computer sends an electrical signal to an optical test pattern generator, or BERT, which then sends an optical test signal to the ROSA. The ROSA receives the test pattern, converts it to an electrical signal, and sends that signal to the test circuit. The host computer then evaluates the return signal from the test circuit to determine whether the optical component is functioning properly.

In another aspect of the present invention, an optical component is tested, using the same tester assembly, in a plurality of test apparatuses. The optical component can also be tested in multiple test environments using the same tester assembly.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings, in which:

FIG. 1 illustrates a block diagram of an optical subassembly tester in accordance with an embodiment of the present invention;

FIG. 2 is a block diagram of an optical subassembly tester with a TOSA in accordance with an embodiment of the present invention;

FIG. 3 is a block diagram of an optical subassembly tester with a ROSA in accordance with an embodiment of the present invention;

FIG. 4A is a schematic drawing of the clamp mechanism of an optical subassembly tester in the open position in accordance with an embodiment of the present invention;

FIG. 4B is a schematic drawing of the clamp mechanism of an optical subassembly tester in the closed position in accordance with an embodiment of the present invention; and

FIG. 4C is a schematic drawing of the clamp assembly of an optical subassembly tester in the unengaged position in accordance with an embodiment of the present invention;

FIG. 4B is a schematic drawing of the clamp mechanism of an optical subassembly tester in the engaged position in accordance with an embodiment of the present invention; and

FIG. 4E is a schematic drawing of the clamp assembly of an optical subassembly tester in the unengaged position in accordance with an embodiment of the present invention;

FIG. 4F is a schematic drawing of the clamp mechanism of an optical subassembly tester in the engaged position in accordance with an embodiment of the present invention;

FIG. 5 is a flowchart of the general method in which the optical subassembly tester may be used to test the optical component of an optoelectronic device; and

FIG. 6 is a block diagram of an optical subassembly tester in accordance with an embodiment of the present invention.

### DETAILED DESCRIPTION OF THE PREFERRED EMBODIMENTS

Preferred embodiments of the invention are described below. In the interest of clarity, not all features of an actual implementation are described. It will be appreciated that in the development of any such embodiment, numerous implementation-specific decisions must be made to achieve the developers' specific goals, such as compliance with system-related and business-related constraints, which will vary from one implementation to another.

Moreover, it will be appreciated that such a development effort might be complex and time-consuming, but would nevertheless be a routine undertaking for those of ordinary skill in the art having the benefit of this disclosure.

Embodiments of the present invention relate to systems and methods of testing the optical components of an optoelectronic device. As used herein, the term “optoelectronic device” generally includes any device which contains both optical and electrical components for receiving and/or transmitting optical and/or electrical signals.

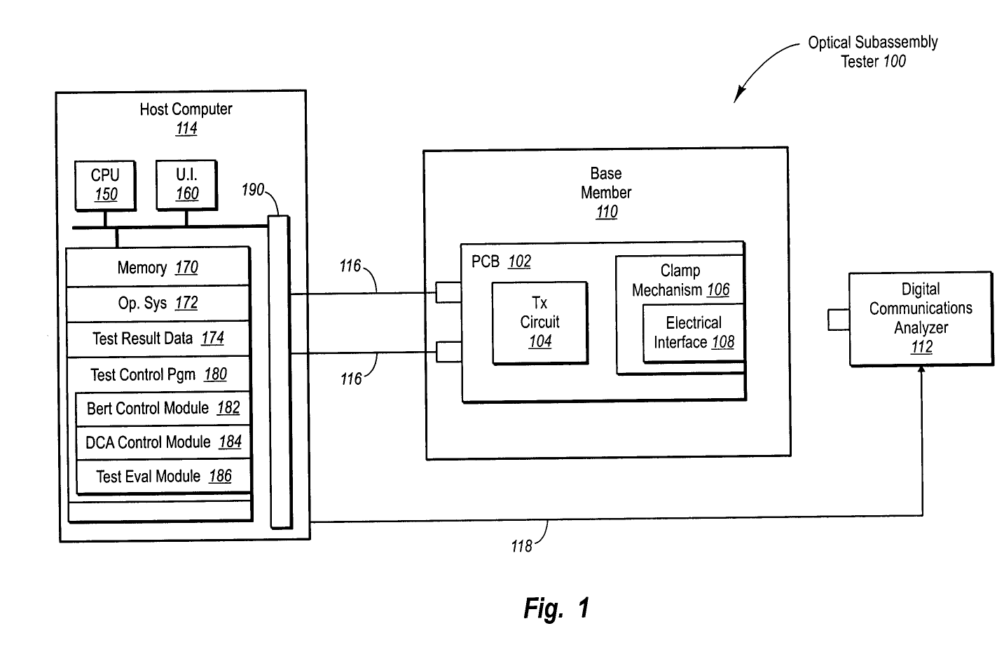

FIG. 1 is a block diagram of a system for testing an optical subassembly in accordance with an embodiment of the present invention. The optical subassembly tester 100 includes a printed circuit board (“PCB”) 102 mounted on a base member 110. A test circuit 104 is in turn mounted on the PCB 102. For embodiments where the transmitting optical components are being tested, the test circuit 104 corresponds to suitable circuitry, represented in FIG. 1 as a Tx circuit 104. When the test circuit 104 is electrically couple to the PCB 102, a printed circuit board assembly (PCBA) is formed.

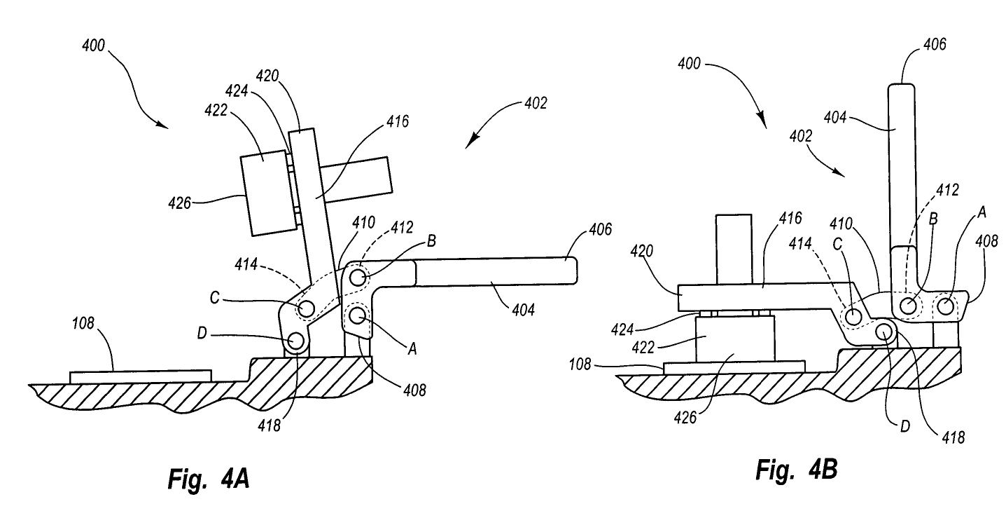

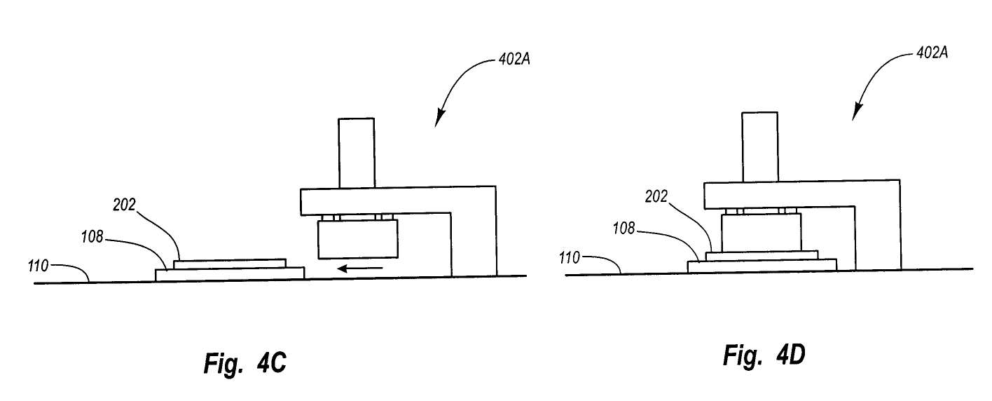

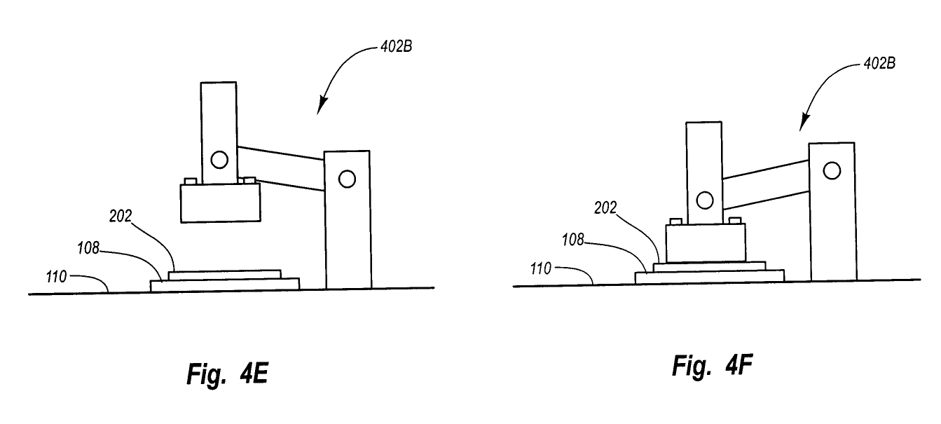

The test circuit 104 conveys test signals between a tester (e.g., a bit error rate tester), test controller or host computer 114 and an optical subassembly such as a Transmitter Optical Subassembly (“TOSA”) or Receiver Optical Subassembly (“ROSA”). Base member 110 also contains a portion 106 of a clamp assembly 402 (FIGS. 4a and 4b). In addition, base member 110 includes an electrical interface 108 connected to test circuit 104. An electrical connection is thus formed at the electrical interface 108 between the optical subassembly to be tested and the test circuit 104. A tester, test controller or host computer 114 is coupled to the test circuit 104 by signal lines or a bus of signal lines 116.

The host computer 114 preferably contains a user interface 160, one or more interfaces 190 for connection to the test circuit 104, a central processing unit (“CPU”) 150 and a memory 170. The memory 170 may include high speed random access memory and may also include nonvolatile mass storage, such as one or more magnetic disk storage devices. The memory may include mass storage that is remotely located from the central processing unit(s). The memory preferably stores an operating system 172, a test control program 180 and test result data 174.

The operating system 172 has instructions for communicating, processing data, accessing data, storing data, searching data, etc. The test control program 180 may include a digital communications analyzer (“DCA”) control module 184, or a bit error rate tester (“BERT”) control module 182, and a test data evaluation module 186. The test result data 174 is received from the DCA or BERT. The test control program 180 and DCA or BERT control module 184/182 include computer programs or procedures for controlling operation of the DCA 112 or BERT and for receiving test result data from the DCA or BERT. The test evaluation module 186 includes instructions for evaluating the test result data to determine whether the optical component is functioning properly.

The host computer 114 controls the function of the test circuit 104 and the optical subassembly being tested. The host computer 114 is coupled to the test circuit 104 via a bus 116. The host computer 114 transmits test data for the TOSA being tested. The host computer 114 is also coupled to the DCA 112 via a bi-directional bus 118. The DCA 112 transmits test results and/or information based on data received from the TOSA to be tested during the testing process via bus 118 to the host computer 114. The host computer 114 processes, adjusts and records the settings and measurements made during the optical subassembly testing process.

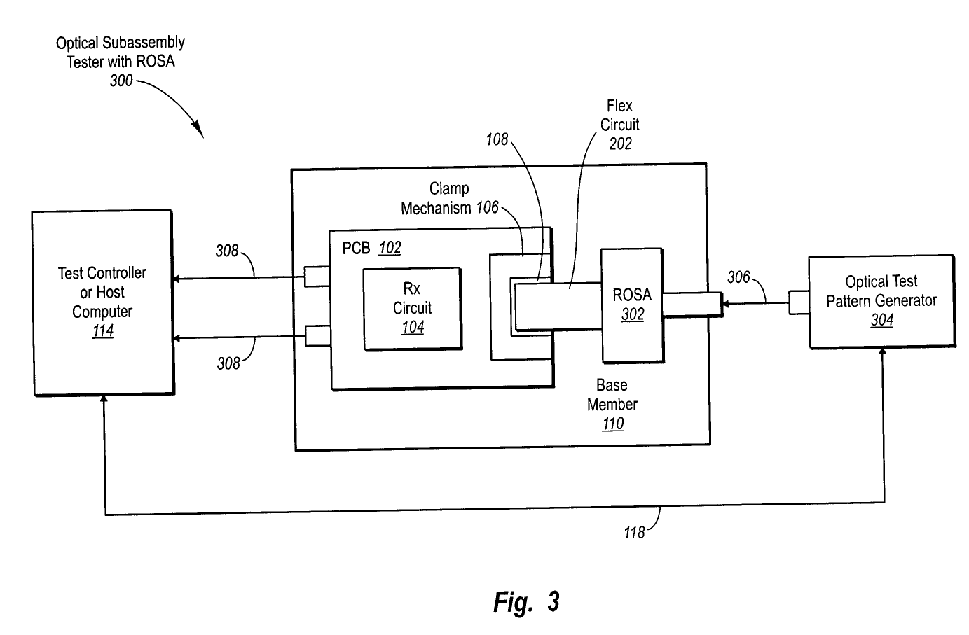

FIG. 3 illustrates an alternate configuration where a ROSA is the optical subassembly to be tested, a tester is configured to test a ROSA, indicated as tester 300. In embodiments where the receiving optical components of an optoelectronic device are being tested, the testing circuit 104 corresponds to suitable circuitry, represented in FIG. 3 as Rx circuit 104. Tester 300 includes an optical test pattern generator 304, such as a BERT, substituted for the DCA 112.

Alternatively, analysis of the test signal for compliance with operating requirements can be done manually by viewing with a scope, such as a DCA 112, that displays the test signal. Necessary adjustments to control parameters are then communicated to the host computer 114 by the viewer until operating requirement compliance is achieved.

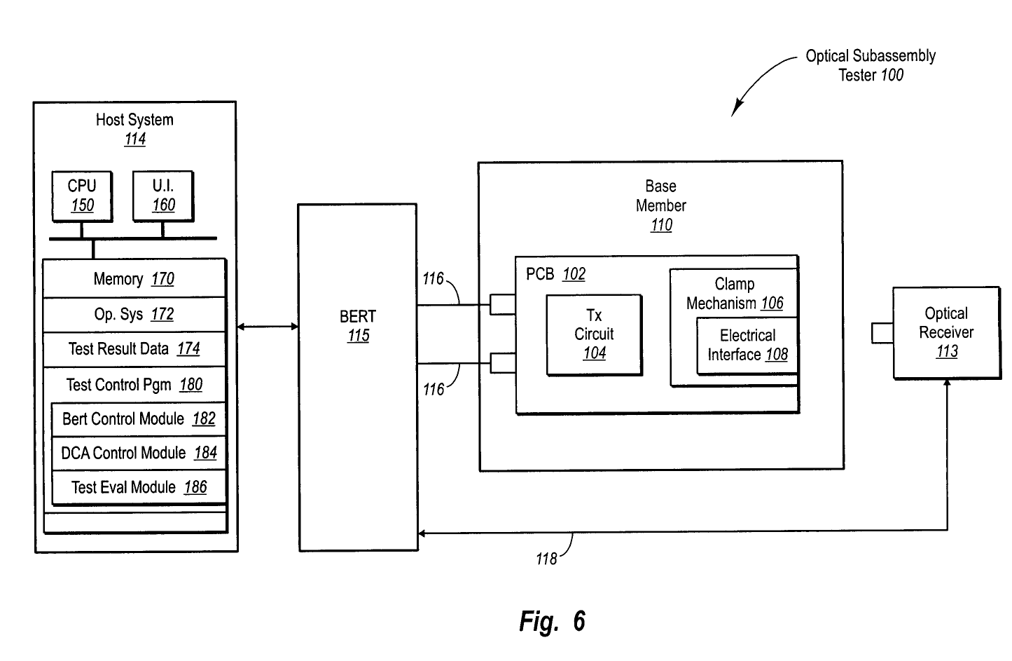

FIG. 6 is a block diagram of a system similar to the system shown in FIG. 1, but using a bit error rate tester (BERT) 115 and optical receiver 113. The optical receiver 113 may be a simple optical receiver, a DCA, or both. In this embodiment, the host computer 114 controls the operation of the BERT 115, using its BERT control module 182. The BERT 115 sends test patterns to the optical subassembly (e.g., a TOSA) via the test circuit 104, and receives return data that it analyzes to determine a bit error rate associated with the optical subassembly undergoing the testing. A similar ROSA testing system can be used to test ROSA's, by replacing the optical receiver with an optical transmitter. In ROSA testing system, the BERT sends test data patterns to the optical transmitter and receives return data from the test circuit 104.

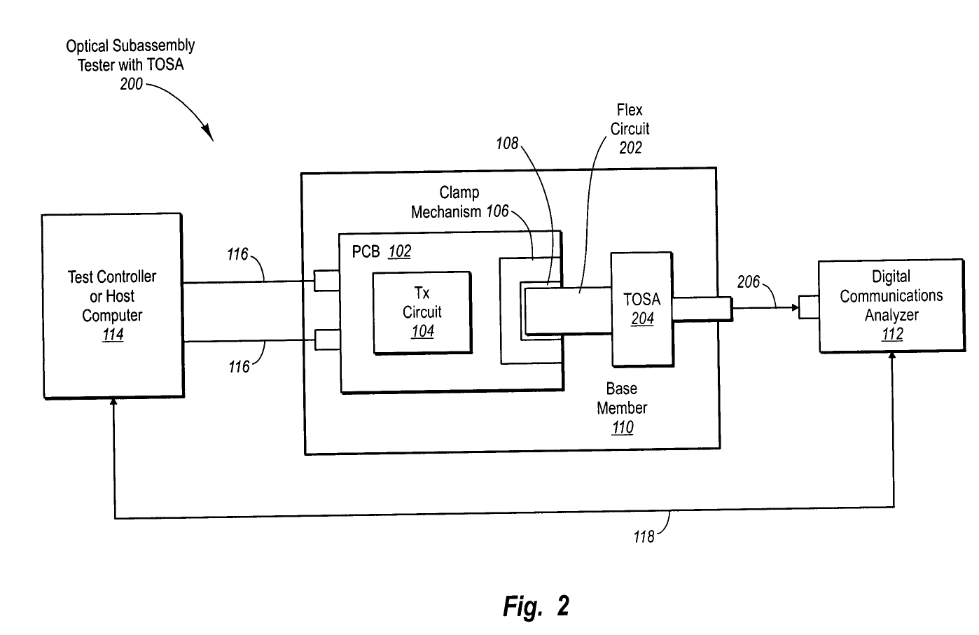

FIG. 2 is a block diagram of a system 200 for testing a TOSA 204 in accordance with an embodiment of the present invention. The configuration allows a TOSA 204 of an optoelectronic device to be tested in certain environments, using a DCA 112 to receive an optical signal from the TOSA 204. The DCA 112, the test circuit 104 and the environment in which the TOSA 204 is tested are controlled by a host computer 114.

In this embodiment, the test circuit 104 is contained in a printed circuit board (“PCB”) 102 that sits in an optical subassembly tester's 200 base member 110. The optical subassembly tester 200 may optionally be placed in a controlled environment test chamber. In some embodiments, the test circuit 104 is a replica of the circuitry, or a portion of the circuitry, in an optoelectronic device. Thus, the test circuit 104 may include the circuitry for biasing the TOSA 204 to be tested, circuitry for driving the TOSA with a data signal, and may further include control circuitry that receives commands from the host computer 114 via lines 116 for controlling the biasing of the TOSA 204.

The electrical receiving end of the TOSA 204 to be tested is coupled to a flexible or flex circuit 202. The coupling of the flex circuit 202 to the TOSA 204 is preferably a solder or similar high quality electrical connection. While a flex circuit is described as the electrical receiving end of the optical subassembly to be tested, those skilled in the art will understand that other electrical means may be provided such as various lead systems known in the art. The flex circuit 202 is connected to the test circuit 104 at an electrical interface 108 (FIG. 1) on the PCB 102 by closing a clamping mechanism 106 to secure a high quality electrical connection that is temporary for purposes of conducting the test of the TOSA 204.

The DCA 112 is configured to receive test signal transmissions from the TOSA 204 via a fiber optic connection 206. The DCA 112 is connected via a bus 118 to the host computer 114 for transmitting and receiving test data and commands.

The host computer 114 controls the test data conditions as well as the DCA's 112 functioning. An electrical test signal is fed from the host computer 114 or BERT to the test circuit 104 through at least one bus 116 and to the TOSA 204 via the flex circuit 202. A resulting optical test output signal is then transmitted from the TOSA 204 through an optical fiber 206 and is received by the DCA 112 which is coupled to the host computer 114. The DCA 112 analyzes the test signal for compliance with preprogrammed operating requirements. The DCA 112 then transmits the results of its analysis to the host computer 114 for further adjustment of the control parameters if necessary. The test data results are then stored in the host computer 114 for later use. In addition, the DCA converts the optical signal it receives into a data stream that is conveyed back to the host computer 114 or BERT for comparison with the data stream transmitted to the TOSA 204.

FIG. 3 is a block diagram of a system 300 for testing a ROSA 302 in accordance with an embodiment of the present invention. Unlike the testing of a TOSA, the goal of testing a ROSA is to test the ROSA's ability to convert an optical signal to an electrical signal. In this embodiment, as in the case of the TOSA test setup, the test circuit 104 is contained in a printed circuit board (“PCB”) 102 that sits in an optical subassembly tester's 200 base member 110. The optical subassembly tester 200 may optionally be placed in a controlled environment test chamber. The test circuit 104 is connected to the host computer 114, which transmits commands to the test circuit 104 and receives test signals from the test circuit 104. The test circuit 104 is connected to the host computer 114 via one or more control buses 116.

The electrical transmitting end of the ROSA 302 to be tested is coupled to a flex circuit 202. The coupling (of the flex circuit 202 to the ROSA 302) is preferably a solder or similar high quality electrical connection. The flex circuit 202 is connected to the test circuit 104 at an electrical interface 108 (FIG. 1) on the PCB 102 by closing a clamping mechanism 106 to secure a high quality electrical connection that is temporary for purposes of conducting the test of the ROSA 302.

An optical test pattern generator 304, such as a BERT having an optical transmitter at its output port, is configured to transmit test signal transmissions to the ROSA 302 via a fiber optic connection 306. The optical test pattern generator 304 is connected via a bus 118 to the host computer 114 for transmitting and receiving test data and commands.

The host computer 114 controls the test data conditions as well as the optical test pattern generator's 304 functioning. An electrical test signal is fed from the optical test pattern generator 304 to the ROSA 302 via the fiber optic connection 306. A resulting electrical test output signal is then transmitted from the ROSA 302 to the test circuit 104 through the flex circuit 202. The host computer 114 then receives the test output signal from the test circuit 104 via buses 308 and analyzes the test signal in conjunction with data received from the optical test pattern generator 304 for compliance with pre-programmed operating requirements. The host computer 114, based on its analysis of the test results, transmits commands to the optical test pattern generator 304 for further adjustment of the control parameters if necessary. The test data results are then stored in the host computer 114 for later use. In addition, the host computer 114 may send commands to the test circuit 104 to adjust the biasing of the ROSA 302 or to adjust other operating parameters of the test circuit 104 or ROSA 302.

FIG. 4A is a schematic drawing of the clamp mechanism 400 of an optoelectronic device testing assembly in the open or unengaged position and FIG. 4B illustrates the clamp mechanism 400 in the closed or engaged position. The clamp mechanism 400 includes of a base member 110 and a clamping assembly 402 pivotably mounted on the base member 110.

The base member 110 is configured to receive a PCB 102 containing a test circuit 104 with an electrical interface 108. The PCB 102 may be secured to the base member 110 with fastening devices such as screws or spring-loaded pegs. The base member itself may also be secured to a work surface directly or via multiple legs, for example.

The clamping assembly 402 includes a lever 404, a link member 410, a head member 416 and a clamping member 422. The combined movement of these four members creates a clamping action characterized by two distinct clamping positions. The first position creates a moderate clamping force. The second position, also called the closed position, applied by adding more force to the clamping assembly, creates a greater clamping force than the first position and acts to temporarily lock the clamp in place. In a preferred embodiment, the clamping assembly 402 “snaps” into the second position, and stably remains in the second position after it is achieved.

The lever 404 has a first end 406 and a second end 408 and is in the form of an “L” with the long “L” side being at the first end and the short “L” side being at the second end. The first end 406 is configured to rotate by means of pressure applied by the human hand or other mechanical means. Second end 408 of lever 404 is pivotably connected to base member 110 at a first pivot joint A. That is, second end 408 of lever 404 and base member 110 preferably include apertures which are configured to cooperate to receive a pin therethrough. Second end 408 of lever 404 is also pivotably connected to link member 410 at second pivot joint B. That is, second end 408 of lever 404 and link member 410 include apertures which are configured to cooperate to receive a pin therethrough.

The link member 410 has a first end 412 and a second end 414. The first end 412 includes an aperture formed transversely therethrough and configured to receive a pin therethrough to form a pivot joint with the lever 404, as mentioned above. The second end 414 of link member 410 is configured to be pivotably connected to head member 416 at third pivot point C. That is, second end 414 of link member 410 and head member 416 have apertures formed transversely therethrough and cooperating to receive a pin to pivotably connect the two members.

The head member 416 has a first end 418 and a second end 420 and has a shape similar to the letter “Z.” The bend in the “Z” has an aperture formed transversely therethrough and configured to receive a pin therethrough to form pivot point C, as mentioned above. In addition, head member 416 is pivotably connected to base member 110 at fourth pivot point D. That is, the far end of first end 418 includes an aperture formed transversely therethrough which cooperates with a corresponding aperture in base member 110 to receive a pin therethrough to form a pivot joint between the link member 410 and the head member 416, as mentioned above. Finally, the second end 420 of head member 416 is configured to receive at least one pin therethrough to form a perpendicular junction between the head member 416 and the clamping member 422.

The clamping member 422 has a first end 424 and a second end 426. The first end 424 is configured to receive at least one pin therethrough to form a perpendicular junction between the head member 416 and the clamping member 422, as mentioned above. The second end 426 has a planar surface to facilitate clamping the flex circuit 202 (attached to the optical component 428) to the electrical interface 108 when the clamp mechanism 400 is in the closed or engaged position, thereby forming a temporary high quality electrical connection.

The clamping assembly 402 thus provides a trapezoidal pivot mechanism formed by pivot points A, B, C and D. Pivot points A and D connect the clamping assembly 402 to base member 110 while pivot points B and C translate movement from lever 404 to head member 416 via link member 410. Operation of lever 404 from the unengaged position thus moves the clamping member 422 into a first position to provide a moderate clamping force. Applying additional force to lever 404 moves the clamping member 422 into a second position or closed position. The second position creates a greater clamping force serving to temporarily lock the clamp member 422 in place. In a preferred embodiment, the clamping assembly 402 “snaps” into the second position, and stably remains in the second position after it is achieved.

While clamping assembly 402 has been described as four discrete parts, the clamping assembly may also include more or fewer members while still creating the temporary high quality electrical connection described above. In addition, other means may be provided for forming the pivotal connection between the members of the clamping assembly 402 and base member 110 other than a pivot and pin connection as will be understood by those skilled in the art in light of this specification.

Still other means are provided for placing the optical component of the optoelectronic subassembly in temporary electrical connection with the testing apparatuses of the present invention. FIGS. 4C and 4D illustrate another embodiment where the clamping mechanism 402A is slidably coupled to base member 110 such that it moves between an engaged and unengaged position. In the unengaged position, the clamping assembly 402A is positioned away from electrical interface 108. In the engaged position, flexible circuit 202 has been disposed on or at electrical interface 108. Clamping mechanism 402A is moved inward to be disposed over the flexible circuit 202.

The clamping mechanism 402A may provide a two-step clamping mechanism. When it is slid over the electrical interface 108, it may provide a moderate clamping force again flexible circuit 202 onto the electrical interface 108. Additional mechanisms may be provided to provide a second, stronger clamping force which causes flexible circuit 202 to strongly be compressed against electrical interface 108. Alternatively, a one-step sliding movement may be sufficient to place the clamping assembly in contact with electrical interface 108.

FIGS. 4E and 4F illustrate another means for providing a temporary electrical connection between flexible circuit 202 and electrical interface 108. In this embodiment, the clamping assembly 402B is disposed above the electrical interface 108, leaving room for flexible circuit 202 to be disposed on electrical interface 108. mechanisms are provided for bringing the clamping assembly 402B down onto the flexible circuit 202 and providing a strong clamping force to place the flexible circuit in electrical contact with electrical interface 108. Again, the clamping force may be provided in a two-step mechanism which provides a moderate and a strong clamping force.

When a flex circuit is bonded to the optical component, the temporary connection may be created by mechanically pressing bonding pads or electrical connection of the flex circuit to the electrical interface on the test circuit. Magnets, pressure fixtures, screws or other clamping mechanisms are used to help make a secure, temporary connection. Advantageously, the test board and clamping mechanism provide a high quality electrical connection between the OSA and the test board without using solder or other permanent connection means.

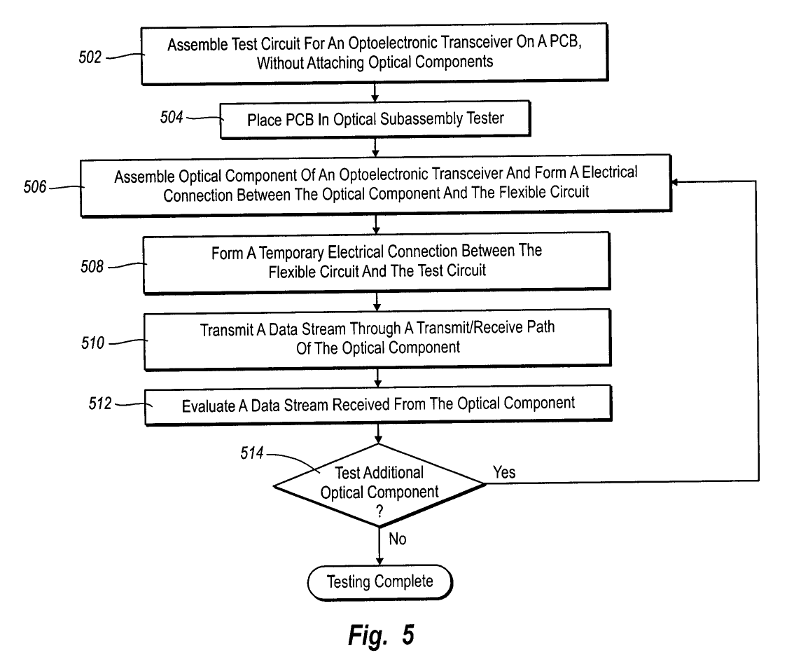

FIG. 5 is a flowchart of the general method in which the optical subassembly tester may be used to test the optical component (i.e., TOSA 204 or ROSA 302) of an optoelectronic device in accordance with an embodiment of the present invention. At step 502, to test an optical component of an optoelectronic device, a test circuit 104 is assembled. The test circuit 104 is formed on a PCB 102 and is configured to transmit or receive test signals to and from the host computer 114 and to be electrically coupled to an optical component at an electrical interface 108. At step 504, the PCB 102 containing the test circuit is then placed 504, and preferably secured, on the base member 110 of the optical assembly tester 100.

At step 506, the optical component is assembled and a high quality electrical connection, preferably a soldered connection, is formed between the optical component and a flex circuit 202. This optical component, if joined with a complimentary optical component (i.e., a ROSA with a TOSA) and an electrical component, would form the internal components of an optoelectronic device. For the present invention, however, the goal is to test an optoelectronic device's optical component before it is joined with the remaining optoelectronic device components. Therefore, an optoelectronic device's optical component must first be assembled without attaching the device's remaining components.

At step 508, the flex circuit 202, which is coupled to the optical component, is placed in contact with the electrical interface of the test circuit 104 formed on the PCB 102 and a clamp mechanism 106 is closed to form a temporary high quality electrical connection. At step 510, a data stream is then transmitted through a transmit/receive path of the optical component, and a resulting data stream is received from the optical component. At step 512, this received data stream is evaluated to determine whether the optical component is functioning properly. Step 514 indicates that steps 506 through 512 may then be repeated in order to test additional optical components. It will be appreciated that some steps may be performed out of the order identified above. For example, the optical component may first be assembled before assembling the tester.

When the optical component to be tested is a receiver optical subassembly (ROSA), an optical signal is sent to the optical input port of the ROSA. If the ROSA is at least partially functional and all necessary connections in the signal path are functional, the ROSA converts the optical signal into an electrical signal, which is then conveyed to a tester or other evaluation device. The electrical signal is evaluated to detect any errors that may indicate a malfunctioning optical component.

When the optical component to be tested is a transmitter optical subassembly (TOSA), an electrical signal is sent to the electrical input port of the TOSA. If the TOSA is at least partially functional and all necessary connections in the signal path are functional, the TOSA converts the electrical signal into an optical signal, which is then conveyed to a tester or other evaluation device. The optical signal is evaluated to detect any errors that may indicate a malfunctioning optical component.

The test assemblies of the present invention enable full data rate testing of the OSA, typically at data rates ranging from 1 Gb/s to 10 Gb/s, as opposed to the simple dead/alive, voltage/current tests performed in the past on OSA's prior to assembly with the device electronics. By testing the OSA's separately from the device electronics, the majority of device failures are detected prior to assembly of the OSA's with the device electronics, thereby greatly reducing the manufacturing costs associated with such failures.

Some aspects of the present invention can be implemented as a computer program product that includes a computer program mechanism embedded in a computer readable storage medium. For instance, the computer program product could contain the program modules contained in the host computer 114 (FIGS. 1-3). These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of testing an optical subassembly (“OSA”) of an optoelectronic device, comprising:
providing a tester apparatus comprising:
a printed circuit board having a test circuit formed thereon, and
an electrical interface disposed in electrical communication with the test circuit;
forming a temporary electrical connection between a secondary circuit and the electrical interface of the tester apparatus;
transmitting a data stream through the OSA; and
evaluating the data stream.

2. The method as recited in claim 1, wherein forming a temporary electrical connection between a secondary circuit and the electrical interface of the tester apparatus further comprises forming an electrical connection between the OSA and the secondary circuit.

3. The method as recited in claim 1, wherein the optical subassembly is one of a transmitter optical subassembly (“TOSA”) and a receiver optical subassembly (“ROSA”).

4. The method as recited in claim 1, wherein the secondary circuit comprises a flexible circuit.

5. The method as recited in claim 1, wherein the secondary circuit comprises a lead system.

6. The method as recited in claim 1, wherein the optical subassembly is a transmitter optical subassembly (TOSA) wherein transmitting a data stream through the TOSA comprises sending a data stream in the form of an input electrical signal from the test circuit to the TOSA, wherein the TOSA outputs a corresponding optical signal.

7. The method as recited in claim 6, wherein evaluating the data stream further comprises analyzing the optical signal from the TOSA using an analyzer.

8. The method as recited in claim 1, further comprising transmitting the results of the evaluation to a computer.

9. The method as recited in claim 6, wherein evaluating the data stream comprises:
converting the optical signal from the TOSA back to an output electrical signal, and
comparing the input electrical signal with the output electrical signal.

10. The method as recited in claim 1, wherein the optical subassembly is a receiver optical subassembly (ROSA) wherein transmitting a data stream through the ROSA comprises sending a data stream in the form of an input optical signal through the ROSA, wherein the ROSA outputs a corresponding data stream in the form of an electrical signal.

11. The method as recited in claim 10, wherein evaluating the data stream further comprising transmitting the electrical signal from the secondary circuit to the test circuit.

12. The method as recited in claim 11, wherein evaluating the data stream further comprises transmitting the electrical signal from the test circuit to a computer.

13. An optical subassembly testing apparatus configured to evaluate an optical subassembly before the optical subassembly is connected to electrical components, the apparatus comprising:
a base member;
a test circuit disposed on the base member;
an electrical interface disposed in electrical communication with the test circuit, the electrical interface configured to be temporarily connected to the optical subassembly; and
means for temporarily placing the optical subassembly in electrical connection with the electrical interface.

14. The apparatus as recited in claim 13, wherein the means for temporarily placing the optical subassembly in temporary electrical connection with the electrical interface comprises a clamping assembly pivotably mounted to the base member.

15. The apparatus as recited in claim 13, wherein the clamping assembly has a plurality of pivot points enabling the clamping assembly to engage the optical subassembly at the electrical interface with at least a connecting force and a locking force, wherein the locking force is greater than the connecting force.

16. The apparatus as recited in claim 13, wherein the means for temporarily placing the optical subassembly in temporary electrical connection with the electrical interface comprises a clamping assembly slidably mounted to the base member.

17. The apparatus as recited in claim 13, wherein the means for temporarily placing the optical subassembly in temporary electrical connection with the electrical interface comprises a clamping assembly disposed above the electrical interface and configured to engage the electrical interface in a press-fit configuration.

18. The apparatus as recited in claim 13, further comprising an analyzer configured to be temporarily connected to the optical subassembly.

19. The apparatus as recited in claim 18, further comprising a computer connected to the test circuit and to the analyzer.

20. The apparatus as recited in claim 18, wherein the analyzer is a bit error rate tester and an optical receiver.

21. The apparatus as recited in claim 18, wherein the analyzer is a bit error rate tester and an optical transmitter.

22. The apparatus as recited in claim 13, further comprising an optical pattern generator configured to be temporarily connected to the optical subassembly.

23. The apparatus as recited in claim 22, further comprising a computer connected to the test circuit and the optical pattern generator.

24. The apparatus as recited in claim 13, wherein the optical subassembly is one of a transmitter optical subassembly (“TOSA”) and a receiver optical assembly (“ROSA”).

25. An optical subassembly testing apparatus configured to evaluate an optical subassembly before the optical subassembly is connected to electrical components, the apparatus comprising:
a base member;
a test circuit disposed on the base member;
an electrical interface disposed in electrical communication with the test circuit, the electrical interface configured to be temporarily connected to the optical subassembly; and
a clamping assembly pivotably mounted to the base member, the clamping assembly configured for temporarily placing the optical subassembly in temporary electrical connection with the electrical interface.

26. The apparatus as recited in claim 25, wherein the clamping assembly has a plurality of pivot points enabling the clamping assembly to engage the optical subassembly at the electrical interface with at least a connecting force and a locking force, wherein the locking force is greater than the connecting force.

27. The apparatus as recited in claim 25, further comprising an analyzer configured to be temporarily connected to the optical subassembly.

28. The apparatus as recited in claim 27, further comprising a computer connected to the test circuit and to the analyzer.

29. The apparatus as recited in claim 27, wherein the analyzer is a bit error rate tester and an optical receiver.

30. The apparatus as recited in claim 27, wherein the analyzer is a bit error rate tester and an optical transmitter.

31. The apparatus as recited in claim 25, further comprising an optical pattern generator configured to be temporarily connected to the optical subassembly.

32. The apparatus as recited in claim 31, further comprising a computer connected to the test circuit and the optical pattern generator.
